(19) United States
(12) Patent Application Publication
(10) Pub. No.: US 2011/0208598 A1
(43) Pub. Date: Aug. 25, 2011

(54) ORDER INPUT APPARATUS AND ORDER INPUT METHOD

(75) Inventors: Hisashi Sato, Shizuoka (JP); Takashi Makiyama, Tokyo (JP); Yumiko Okuma, Tokyo (JP); Masanori Sambe, Shizuoka (JP)

(73) Assignee: TOSHIBA TEC KABUSHIKI KAISHA, Tokyo (JP)

(21) Appl. No.: 13/020,951

(22) Filed: Feb. 4, 2011

(30) Foreign Application Priority Data
Feb. 22, 2010 (JP) 2010-036661

(51) Int. Cl. G06Q 30/00

(52) U.S. Cl. 705/15; 705/27.1

(57) ABSTRACT

According to one embodiment, an order input apparatus includes: a first storing unit configured to store therein plural menu items and plural sub-menu items in association with one another, the sub-menu items accompanying the menu items; a first display control unit configured to display a list of the plural menu items in a first area in a display screen of a display unit; a first receiving unit configured to receive selection of any menu item out of the list of the menu items displayed in the first area; a second display control unit configured to display a list of the sub-menu items accompanying the menu item, the selection of which is received by the first receiving unit, in a second area in the display screen; a second receiving unit configured to receive selection of any sub-menu item out of the list of the sub-menu items displayed in the second area; and an order processing unit configured to manage, as order menu item information, the menu item and the sub-menu item, the selection of which is received by the first receiving unit and the second receiving unit.

### CROSS-REFERENCE TO RELATED APPLICATION

This application is based upon and claims the benefit of priority from the prior Japanese Patent Application No. 2010-36661, filed on Feb. 22, 2010; the entire contents of which are incorporated herein by reference.

### FIELD

Embodiments described herein relate generally to an order input apparatus and an order input method.

### BACKGROUND

In the past, in eating houses such as a restaurant, an order management system including a handy terminal as a portable order input apparatus is installed. In the eating houses in which such a system is installed, each of attendants carries a handy terminal and waits on customers. If the attendant receives an order of food and drink menu items from a customer, the attendant operates an input unit (a keyboard, a touch panel, etc.) of the handy terminal and inputs information concerning the ordered food and drink menu items.

Among food and drink menu items input to the order input apparatus, besides main dishes, there are menu items such as bread and salad that can be selected out of several kinds. In this case, menu items such as bread and salad accompanying dishes of main menu items are referred to as sub-menu items. For example, in some restaurants, a kind of a spread such as butter spread on bread and a kind of dressing poured over salad can be selected. In this case, the spread is information accompanying the bread and the dressing is information accompanying the salad. Menu items such as the spread and the dressing accompanying the sub-menu items are referred to as comment menu items. In this way, the food and drink menu items input to the order input apparatus has a hierarchical structure including the main menu items, the sub-menu items, and the comment menu items.

In the order input apparatus in the past, if an order received from a customer is information concerning a main menu item having sub-menu items, a list of sub-menu items that can be added to the main menu item is displayed in unit of a group of the sub-menu items. Designation of the sub-menu items is sequentially performed according to order set in advance. In this way, in the order input apparatus of this type in the past, until designation of one sub-menu item is completed, the next sub-menu item cannot be designated. Therefore, if the main menu item having sub-menu items is ordered, the sub-menu items can only be designated in the order set in advance. As a result, the order input apparatus cannot deal with an order of sub-menu items arbitrarily designated by a customer and lacks convenience.

### DESCRIPTION OF THE DRAWINGS

FIG. 1 is a schematic diagram of the configuration of a database management system;

FIG. 2 is a diagram of an example of a main menu item file;

FIG. 3 is a diagram of an example of a sub-menu item file;

FIG. 4 is a diagram of an example of a comment menu item file;

FIG. 5 is a diagram of a main part configuration of an order input apparatus;

FIG. 6 is a flowchart for explaining a procedure of order input processing;

FIG. 7 is a flowchart for explaining a procedure of sub-menu item input processing;

FIG. 8 is a flowchart for explaining a procedure of comment menu item input processing;

FIG. 9 is a diagram of an example of a menu item input screen;

FIG. 10 is a diagram of an example of the menu item input screen;

FIG. 11 is a diagram of an example of a sub-menu item input screen;

FIG. 12 is a diagram of an example of the sub-menu item input screen;

FIG. 13 is a diagram of an example of the sub-menu item input screen;

FIG. 14 is a diagram of an example of the sub-menu item input screen;

FIG. 15 is a diagram of an example of a comment menu item input screen;

FIG. 16 is a diagram of an example of the comment menu item input screen;

FIG. 17 is a diagram of an example of the sub-menu item input screen; and

FIG. 18 is a diagram of an example of the menu item input screen.

### DETAILED DESCRIPTION

In general, according to one embodiment, an order input apparatus includes: a first storing unit configured to store therein plural menu items and plural sub-menu items in association with one another, the sub-menu items accompanying the menu items; a first display control unit configured to display a list of the plural menu items in a first area in a display screen of a display unit; a first receiving unit configured to receive selection of any menu item out of the list of the menu items displayed in the first area; a second display control unit configured to display a list of the sub-menu items accompanying the menu item, the selection of which is received by the first receiving unit, in a second area in the display screen; a second receiving unit configured to receive selection of any sub-menu item out of the list of the sub-menu items displayed in the second area; and an order processing unit configured to manage, as order menu item information, the menu item and the sub-menu item, the selection of which is received by the first receiving unit and the second receiving unit.

According to another embodiment, an order input apparatus includes: a first storing unit configured to store therein plural menu items and plural sub-menu items in association with one another, the sub-menu items accompanying the menu items; a first display control unit configured to display a list of the plural menu items in a first area in a display screen of a display unit; a first receiving unit configured to receive selection of any menu item out of the list of the menu items displayed in the first area; a second display control unit configured to display a list of the sub-menu items accompanying the menu item, the selection of which is received by the first receiving unit, in a second area in the display screen; a second receiving unit configured to receive selection of any sub-menu item out of the list of the sub-menu items displayed in the second area; and a third display control unit configured to display a list of the menu item and the sub-menu item, the selection of which is received by the first receiving unit and the second receiving unit, in a third area in the display screen.

According to still another embodiment, an order input method is an order input method executed by an order input apparatus, the order input method including: a first display control unit displaying a list of plural menu items in a first area in a display screen of a display unit; a first receiving unit receiving selection of any menu item out of the list of the menu items displayed in the first area; a second display control unit displaying a list of the sub-menu items accompanying the menu item, the selection of which is received, in a second area in the display screen; a second receiving unit receiving selection of any sub-menu item out of the list of the sub-menu items displayed in the second area; and an order processing unit managing, as order menu item information, the menu item and the sub-menu item, the selection of which is received.

An embodiment is explained below with reference to the accompanying drawings. In an example explained below, the present invention is applied to an order input apparatus of an order management system constructed in an eating house such as a family restaurant. However the present invention is not limited to this embodiment.

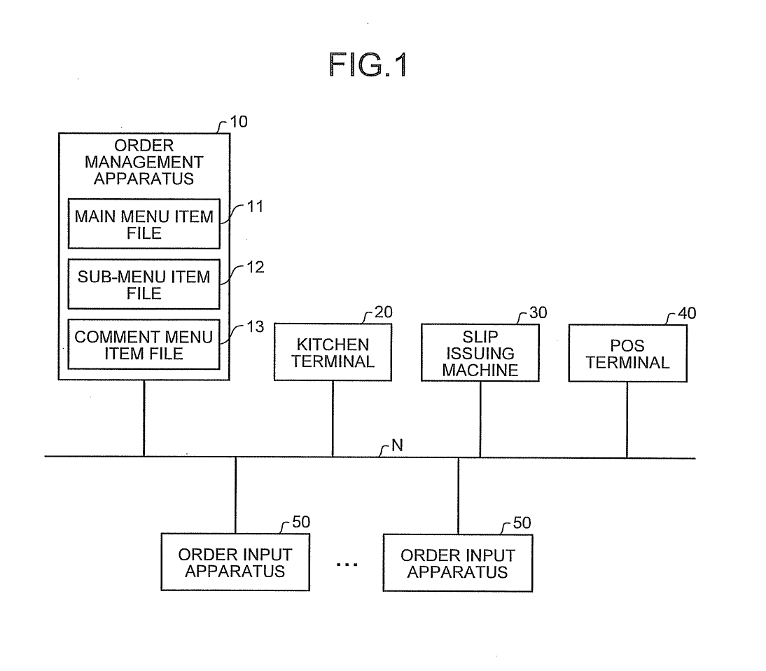

FIG. 1 is a diagram of an overall configuration of an order management system. As shown in the figure, the order management system includes an order management apparatus 10, a kitchen terminal 20, a slip issuing machine 30, a POS terminal 40, and plural order input apparatuses 50.

The order management apparatus 10 is a computer apparatus configured to unitarily manage jobs such as reception of an order of a customer, cooking, and checkout. The order management apparatus 10 is connected to the kitchen terminal 20, the slip issuing machine 30, the POS terminal 40, and the order input apparatuses 50 via a network N such as a LAN (Local Area Network) to be capable of communicating with each other. A communication system between the order management apparatus 10 and the kitchen terminal 20, the slip issuing machine 30, the POS terminal 40, and the order input apparatuses 50 may be wired communication or may be wireless communication.

If the order management apparatus 10 receives order menu item information of customers transmitted from the order input apparatuses 50, the order management apparatus 10 stores and manages the order menu item information for each of the customers, creates cooking instruction data of ordered food and drink menu items, and transmits the cooking instruction data to the kitchen terminal 20. The kitchen terminal 20 outputs a cooking instruction for the ordered food and drink menu items through display, printing, sound, or the like.

The order management apparatus 10 creates printing data of an order slip on the basis of the order menu item information and transmits the printing data to the slip issuing machine 30. The slip issuing machine 30 prints and issues an order slip for each of the customers.

If a slip number of a customer checking out in the POS terminal 40 is input to the order management apparatus 10, the order management apparatus 10 reads out order menu item information of the customer identified by the slip number and transmits the order menu item information to the POS terminal 40. The POS terminal 40 executes checkout processing for food and drink prices.

A storage device such as a hard disk included in the order management apparatus 10 has stored therein a main menu item file 11, a sub-menu item file 12, and a comment menu item file 13 as data files for supporting order item input processing in the order input apparatuses 50. The data files are downloaded to the order input apparatuses 50 via the network N.

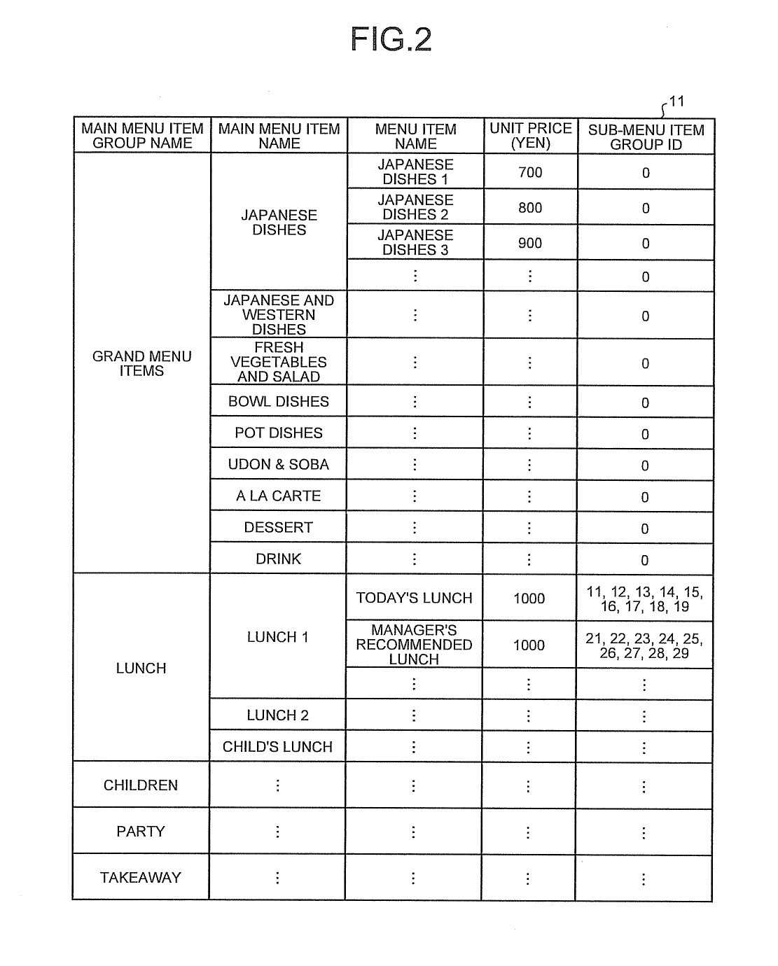

In the main menu item file 11, as shown in FIG. 2, names of main menu item groups (main menu item group names) set as large items for classifying food and drink according to kinds and service forms of the food and drink and names of main menu items (main menu item names) belonging to the main menu item groups are stored in association with each other. Names of menu items (menu item names) belonging to the main menu items set as intermediate items for classifying the food and drink are stored as small items in association with the main menu items.

Main menu item group names shown in an example of FIG. 2 include “grand menu” in which food and drink menu items provided as single menu items are classified, “lunch” in which food and drink menu items provided as lunch sets are classified, “children” in which food and drink menu items provided as menu items for children are classified, “party” in which food and drink menu items provided as menu items for parties are classified, and “takeaway” in which food and drink menu items provided as menu items for takeaway are classified. For example, as main menu item names belonging to “grand menu”, “Japanese dishes”, “Japanese and Western dishes”, and the like are associated. As menu item names belonging to this main menu item name “Japanese dishes”, “Japanese dishes 1”, “Japanese dishes 2”, and the like are associated.

A sub-menu item group ID corresponding to a sub-menu item group ID stored in the sub-menu item file 12 is stored as information concerning sub-menu items in association with each of the menu item names besides a unit price of the menu item name. The sub-menu items are food and drink items added to a dish of the menu item name. One or plural items are selected out of plural items as the sub-menu items. The sub-menu item group ID “0” means that a menu item has no sub-menu item.

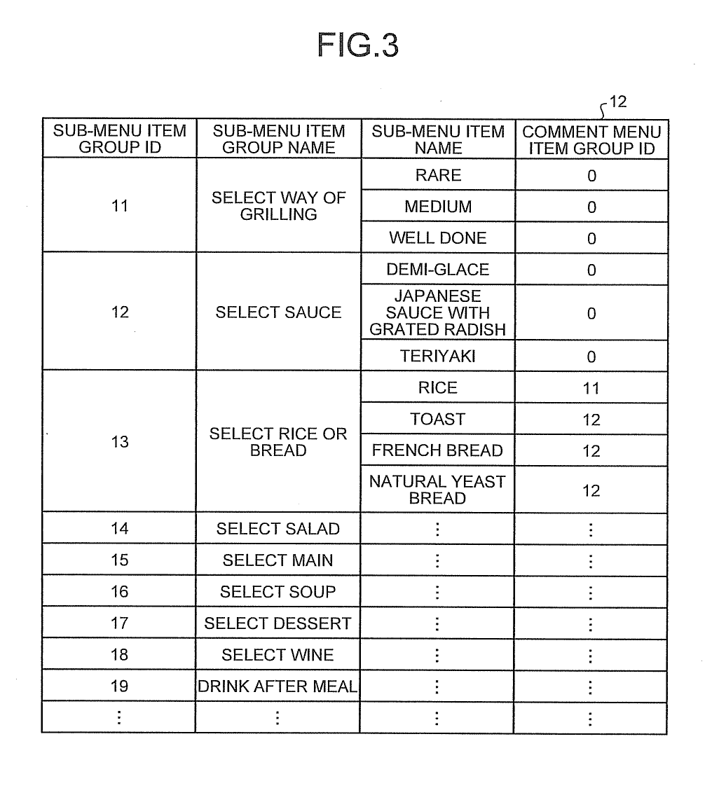

In the sub-menu item file 12, as shown in FIG. 3, with uniquely-set sub-menu item group IDs as keys, names of sub-menu item groups (sub-menu item group names) identified by the group IDs and information concerning sub-menu items belonging to the sub-menu item groups are stored. In the information concerning the sub-menu items, besides names of the sub-menu items (sub-menu item names), comment menu item group IDs indicating classifications of comment menu items accompanying the sub-menu items are stored. The comment menu items are items accompanying the sub-menu items. For example, a kind of a spread on bread, time for providing drink, and the like correspond to the comment menu items. Comment menu item group IDs in the sub-menu item file 12 correspond to the comment menu item group IDs registered in the comment menu item file 13. The sub-menu item group ID “0” means that a sub-menu item has no comment menu item.

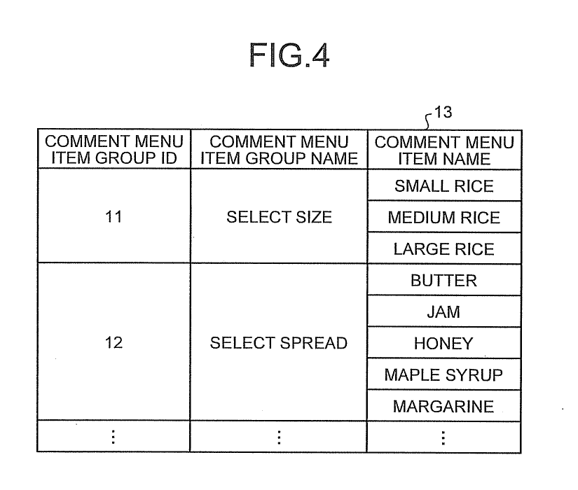

In the comment menu item file 13, as shown in FIG. 4, with uniquely-set comment menu item group IDs as keys, names of comment menu item groups identified by the group IDs and information concerning comment menu items belonging to the comment menu item groups are stored. The information concerning the comment menu items include items set for each of the comment menu items (the quantity of rice, a kind of a spread on bread, etc.)

Referring back to FIG. 1, each of the order input apparatuses 50 is an order input apparatus served for inputting information concerning main menu items (menu items), an order of which is received from a customer.

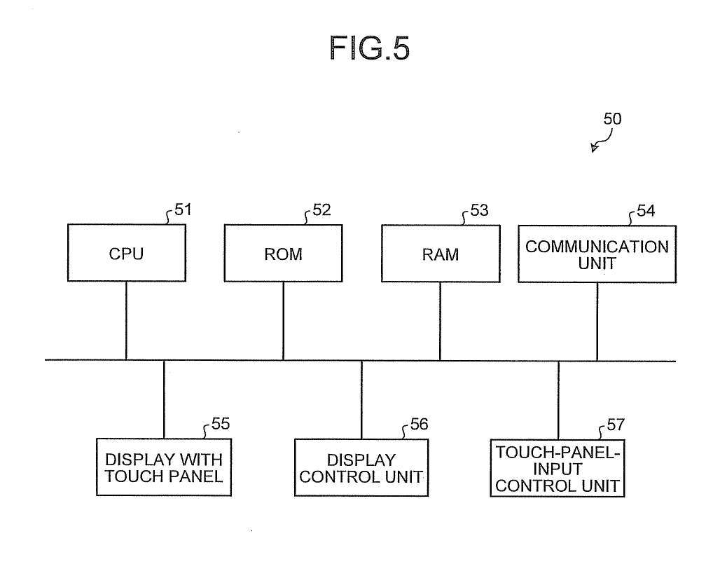

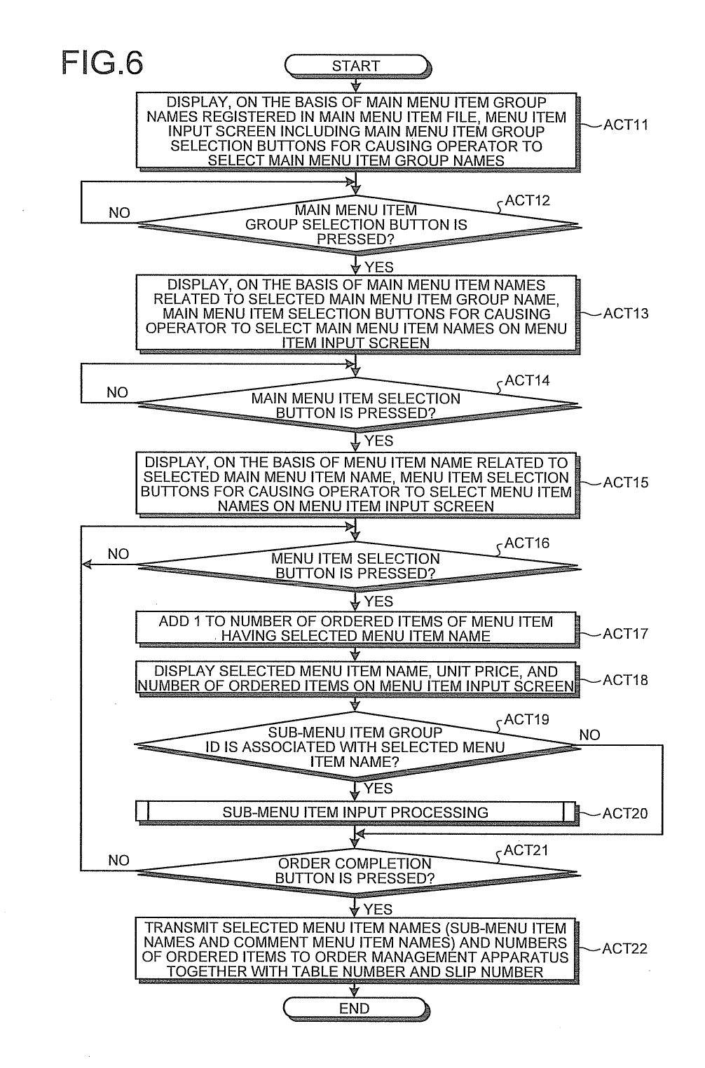

FIG. 5 is a diagram of a main part configuration of the order input apparatus 50. As shown in the figure, the order input apparatus 50 includes a CPU (Central Processing Unit) 51 as a control unit configured to collectively control the operation of the order input apparatus 50, a ROM (Read Only Memory) 52 having stored therein in advance fixed data such as a computer program related to order input processing (see FIG. 6) explained later, a RAM (Random Access Memory) 53 to which the data files (the main menu item file 11, the sub-menu item file 12, and the comment menu item file 13) provided by the order management apparatus 10 are downloaded, a communication unit 54 that can be connected to the network N, a display control unit 56 that controls screen display on a display with touch panel 55 according to the control by the CPU 51, and a touch-panel-input control unit 57 configured to control touch panel input. The CPU 51, the ROM 52, the RAM 53, the communication unit 54, the display control unit 56, and the touch-panel-input control unit 57 are connected by a bus line such as an address bus or a data bus.

Besides an area for storing the data files, information concerning menu items, an order of which is decided by the order input processing explained later, the number of ordered items of the menu items, and the like are stored in the RAM 53. The information, the number of ordered items, and the like are managed as order menu item information under the control by the CPU 51.

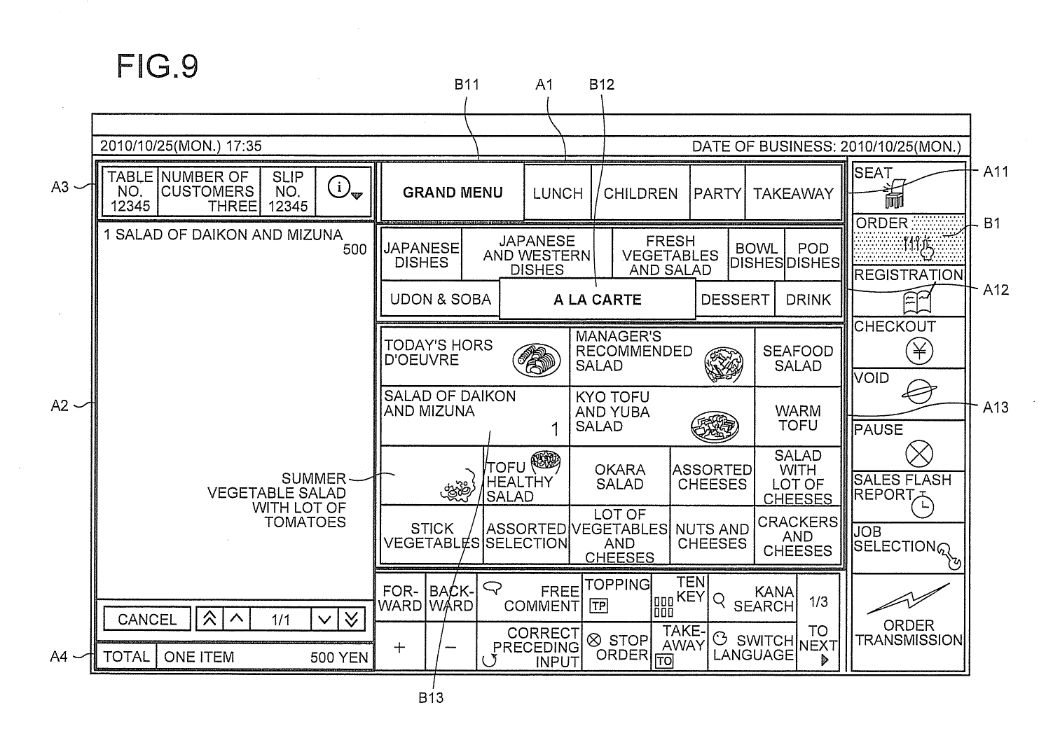

The order input apparatus 50 having such a configuration is programmed such that, with input of a button (see a button B1 shown in FIG. 9) for instructing the start of order reception as a trigger, the CPU 51 executes the order input processing shown in flowcharts of FIGS. 6 to 8. A procedure of the order input processing is explained below.

First, the CPU 51 reads out the main menu item group names registered in the main menu item file 11 and causes the display with touch panel 55 to display a menu item input screen including buttons for causing an operator to select the main menu item group names (hereinafter referred to as main menu item group selection buttons) (Act 11).

Subsequently, the CPU 51 stays on standby until any one of the main menu item group selection buttons is pressed (No in Act 12). If the CPU 51 receives a pressing signal via the touch-panel-input control unit 57 (Yes in Act 12), the CPU 51 reads out, from the main menu item file 11, main menu item names related to the main menu item group name selected by the pressing of the main menu item group selection button and causes the display with touch panel 55 to display buttons for causing the operator to select the main menu item names (hereinafter referred to as main menu item selection buttons) on the menu item input screen (Act 13). If a main menu item group selection button is pressed between Act 14 to Act 21 explained later, the CPU 51 performs processing from Yes in Act 12 to Act 13 for the pressed (selected) main menu item group selection button.

The CPU 51 stays on standby until any one of the main menu item selection buttons is pressed (No in Act 14). If the CPU 51 receives a pressing signal via the touch-panel-input control unit 57 (Yes in Act 14), the CPU 51 reads out, from the main menu item file 11, menu item names related to a main menu item name selected by the pressing of the main menu item selection button and causes the display with touch panel 55 to display buttons for causing the operator to select the menu item names (hereinafter menu item selection buttons) on the menu item input screen (Act 15). If a main menu item selection button is pressed between Act 16 to Act 21 explained later, the CPU 51 performs processing in Yes in Act 14 to Act 15 for the pressed (selected) main menu item selection button.

The CPU 51 stays on standby until any one of the menu item selection buttons is pressed (No in Act 16). If the CPU 51 receives a pressing signal via the touch-panel-input control unit 57 (Yes in Act 16), the CPU 51 adds 1 to the number of ordered items of a menu item having the menu item name selected by the pressing of the menu item selection button (Act 17) and causes the display with touch panel 55 to display the selected menu item name, a unit price, and the number of ordered items on the menu item input screen (Act 18). In this way, the CPU 51 cooperates with the touch-panel-input control unit 57 to function as the first receiving unit.

The CPU 51 determines whether a sub-menu item group ID is associated with the selected menu item name (Act 19). If the CPU 51 determines that no sub-menu item group ID is associated with the selected menu item name, i.e., if the CPU 51 determines that the sub-menu item group ID is “0” (No in Act 19), the CPU 51 immediately shifts to Act 21. If the CPU 51 determines that a sub-menu item group ID is associated with the selected menu item name (Yes in Act 19), the CPU 51 executes sub-menu item input processing (Act 20) and shifts to Act 21.

FIG. 9 is a diagram of an example of a menu item input screen displayed on the display with touch panel 55 by the cooperation of the CPU 51 and the display control unit 56. As shown in the figure, the CPU 51 and the display control unit 56 (a first display control unit and a third display control unit) display a menu item input screen including an area A1 (a first area) for selectably displaying a list of menu items and an area A2 (a third area) for displaying information concerning menu items, an order of which is received. The button B1 is a button for instructing the start of the order input processing.

In the area A1, an area A11 is an area in which main menu item group selection buttons are displayed. In the example shown in FIG. 9, five main menu item group selection buttons corresponding to the main menu item group names shown in FIG. 2 are displayed.

An area A12 is an area in which main menu item selection buttons are displayed. In the example shown in FIG. 9, nine main menu item selection buttons corresponding to main menu item names associated with the main menu item names shown in FIG. 2 are displayed according to pressing of a main menu item group selection button B11 corresponding to the main menu item group name “grand menu”.

An area A13 is an area in which menu item selection buttons are displayed. In the example shown in FIG. 9, sixteen menu item selection buttons corresponding to menu item names associated with a main menu item name “a la carte” are displayed in the area A13 according to pressing of a main menu item selection button B12 corresponding to the main menu item name.

An area A2 is an area for displaying a menu item name, the number of ordered items, and a unit price of a menu item, an order of which is received. Above the area A2, an area A3 for displaying a table number, the number of customers, a slip number, and the like of a customer whose order is received is arranged. Under the area A2, an area A4 for displaying a total number and a total amount of items, an order of which is received, is arranged. The table number and the number of customers in the area A3 are input according to a predetermined guide screen displayed according to pressing of a button B2.

If a menu item selection button B13 corresponding to a menu item name “salad of daikon and mizuna” is pressed in the area A13 shown in FIG. 9 in Act 16 described above, the CPU 51 adds 1 to the number of ordered items of a menu item having the menu item name and causes the display with touch panel 55 to display a numerical value “1” representing the number of ordered items on the menu item selection button B13. The CPU 51 causes the display with touch panel 55 to display the number of ordered items “1”, the selected menu item name “salad of daikon and mizuna”, and a unit price (500 yen) in the area A2 in association with one another. The CPU 51 calculates a total number of the numbers of ordered items and a total amount of items displayed in the area A2 and causes the display with touch panel 55 to display the total number and the total amount in the area A4. In this case, since a sub-menu item group ID is not associated with the selected menu item name “salad of daikon and mizuna”, the CPU 51 immediately shifts to Act 21.

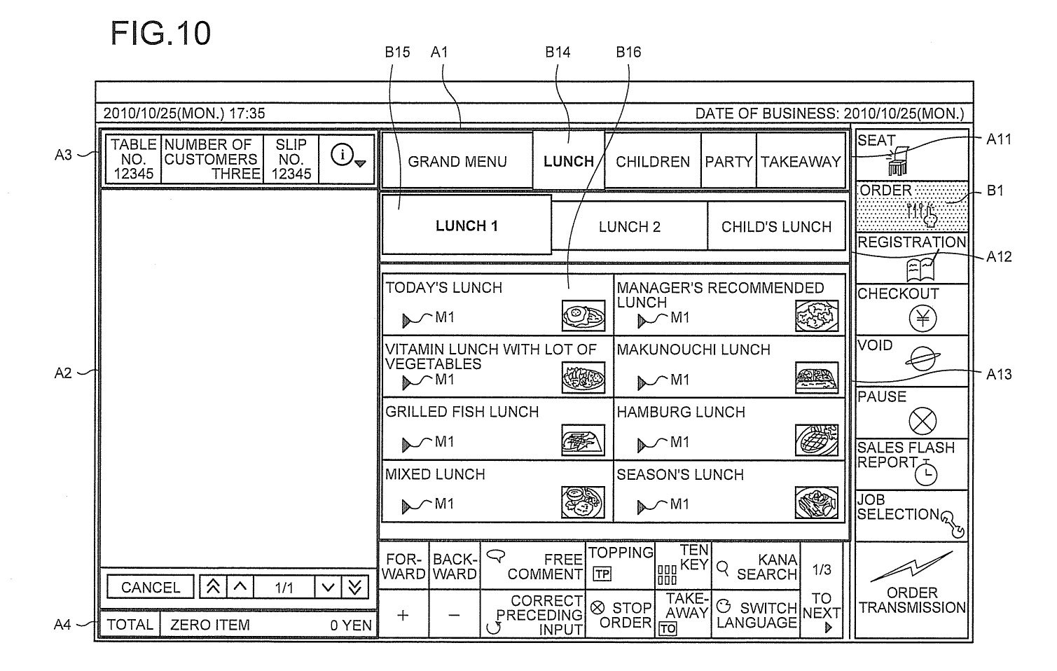

If a main menu item group selection button B14 corresponding to the main menu item group name “lunch” is pressed in the area A11, a screen shown in FIG. 10 is displayed. In an example shown in FIG. 10, three main menu item selection buttons corresponding to main menu item names associated with the main menu item group name “lunch” are displayed in the area A12. In the example shown in FIG. 10, eight menu item selection buttons corresponding to menu item names associated with a main menu item name “lunch 1” are displayed in the area A13 according to pressing of a main menu item selection button B15 corresponding to the main menu item name “lunch 1”. Since sub-menu item group IDs are associated with the menu item names, the CPU 51 causes the display with touch panel 55 to display, on the menu item selection buttons, information M1 of a rectangular shape indicating that sub-menu items are present.

If a menu item selection button B16 corresponding to a menu item name “today's lunch” is pressed in the area A13, the CPU 51 adds 1 to the number of ordered items of a menu item having the menu item name and causes the display with touch panel 55 to display a numerical value “1” representing the number of ordered items on the menu item selection button B16. The CPU 51 causes the display with touch panel 55 to display the number of orders, the selected menu item name “today's lunch”, and a unit price (1000 yen) in the area A2 in association with one another. The CPU 51 calculates a total number of the numbers of orders and a total amount of items displayed in the area A2 and causes the display with touch panel 55 to display the total number and the total amount in the area A4. In this case, since a sub-menu item group ID is associated with the selected menu item name “today's lunch”, the CPU 51 executes the sub-menu item input processing in Act 20.

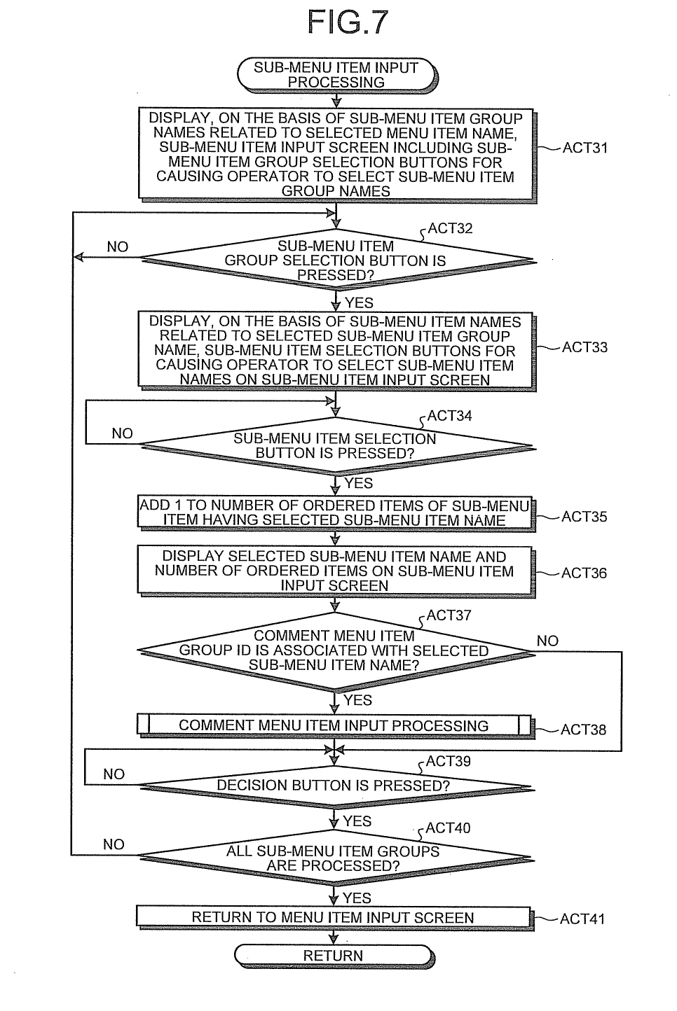

The sub-menu item input processing in Act 20 is explained below with reference to FIG. 7. FIG. 7 is a flowchart for explaining a procedure of the sub-menu item input processing executed by the CPU 51.

First, the CPU 51 reads out, from the sub-menu item file 12, sub-menu item group names associated with sub-menu item group IDs of the menu item name selected in ACT 16. The CPU 51 causes the display with touch panel 55 to display a sub-menu item input screen including buttons for causing the operator to select the sub-menu item group names (hereinafter referred to as sub-menu item group selection buttons) (Act 31)

Subsequently, the CPU 51 stays on standby until any one of the sub-menu item group selection buttons is pressed (No in Act 32). If the CPU 51 receives a pressing signal of the sub-menu item group selection button via the touch-panel-input control unit 57 (Yes in Act 32), the CPU 51 reads out, from the sub-menu item file 12, sub-menu item names related to the sub-menu item group name selected by the pressing and causes the display with touch panel 55 to display buttons for causing the operator to select the sub-menu item names (hereinafter referred to as sub-menu item selection buttons) on the sub-menu item input screen (Act 33)

The CPU 51 stays on standby until any one of the sub-menu item selection buttons is pressed (No in Act 34). If the CPU 51 receives a pressing signal of the sub-menu item selection button via the touch-panel-input control unit 57 (Yes in Act 34), the CPU 51 adds 1 to the number of ordered items of a sub-menu item having the sub-menu item name selected by the pressing (Act 35) and causes the display with touch panel 55 to display the selected sub-menu item name and the number of ordered items on the sub-menu item input screen (Act 36). In this way, the CPU 51 cooperates with the touch-panel-input control unit 57 to function as a second receiving unit.

The CPU 51 determines whether a comment menu item group ID is associated with the selected sub-menu item name (Act 37). If the CPU 51 determines that a comment menu item group ID is not associated with the selected sub-menu item name, i.e., if the CPU 51 determines that a comment menu item group ID is “0” (No in Act 37), the CPU 51 immediately shifts to Act 39. If the CPU 51 determines that a comment menu item group ID is associated with the selected sub-menu item name (Yes in Act 37), the CPU 51 executes comment menu item input processing explained later (Act 38) and shifts to Act 39.

In Act 39, the CPU 51 stays on standby until a button for deciding an order of a sub-menu item is pressed (No in Act 39). If the CPU 51 receives pressing of the button (Yes in Act 39), the CPU 51 shifts to Act 40. In Act 40, the CPU 51 determines whether the processing in Acts 32 to 39 is applied to all the sub-menu item groups displayed in Act 31. If an unprocessed sub-menu item group is present (No in Act 40), the CPU 51 returns to Act 32.

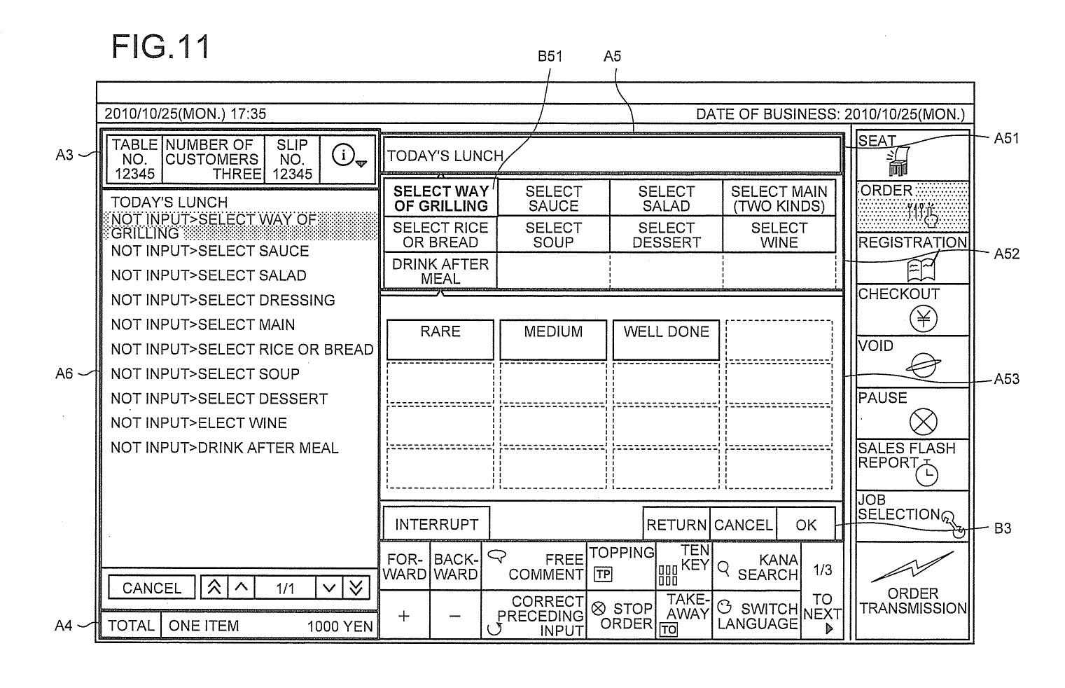

FIG. 11 is a diagram of an example of a sub-menu item input screen displayed on the display with touch panel 55 by cooperation of the CPU 51 and the display control unit 56. As shown in the figure, the CPU 51 and the display control unit 56 (a second display control unit and the third display control unit) display a sub-menu item input screen including an area A5 (a second area) for selectably displaying a list of sub-menu items and an area A6 (a third area) for displaying information concerning a sub-menu item group, an order of which is received. In the sub-menu item input screen, the areas A1 and A2 of the menu item input screen are switched to the areas A5 and A6.

In the area A5, an area A51 is an area for displaying the menu item name selected in Act 16. In the example shown in FIG. 11, the menu item name “today's lunch” is selected.

An area A52 is an area in which sub-menu item group selection buttons are displayed. In the example shown in FIG. 11, according to selection of the menu item name “today's lunch”, nine sub-menu item group selection buttons corresponding to sub-menu item group IDs “11 to 19” shown in FIG. 3 are displayed in the area A52.

An area A53 is an area in which sub-menu item selection buttons are displayed. In the example shown in FIG. 11, according to selection of a sub-menu item group selection button B51 corresponding to a sub-menu item group name “select a way of grilling”, three sub-menu item selection buttons corresponding to sub-menu items names associated with the sub-menu item group name are displayed in the area A53. A button B3 under the area A53 is a button for deciding an order of a sub-menu item.

The area A6 is an area for displaying information concerning sub-menu items. In the area A6, a list of sub-menu items accompanying a selected menu item name is displayed to make it possible to distinguish whether the sub-menu items are selected (ordered). In the example shown in FIG. 11, the selected menu item name “today's lunch” is displayed and sub-menu item group names accompanying the menu item name are displayed as a list. “Not input” is written for unselected sub-menu item group names, whereby the sub-menu item group names are displayed to make it possible to distinguish whether the sub-menu item group names are selected.

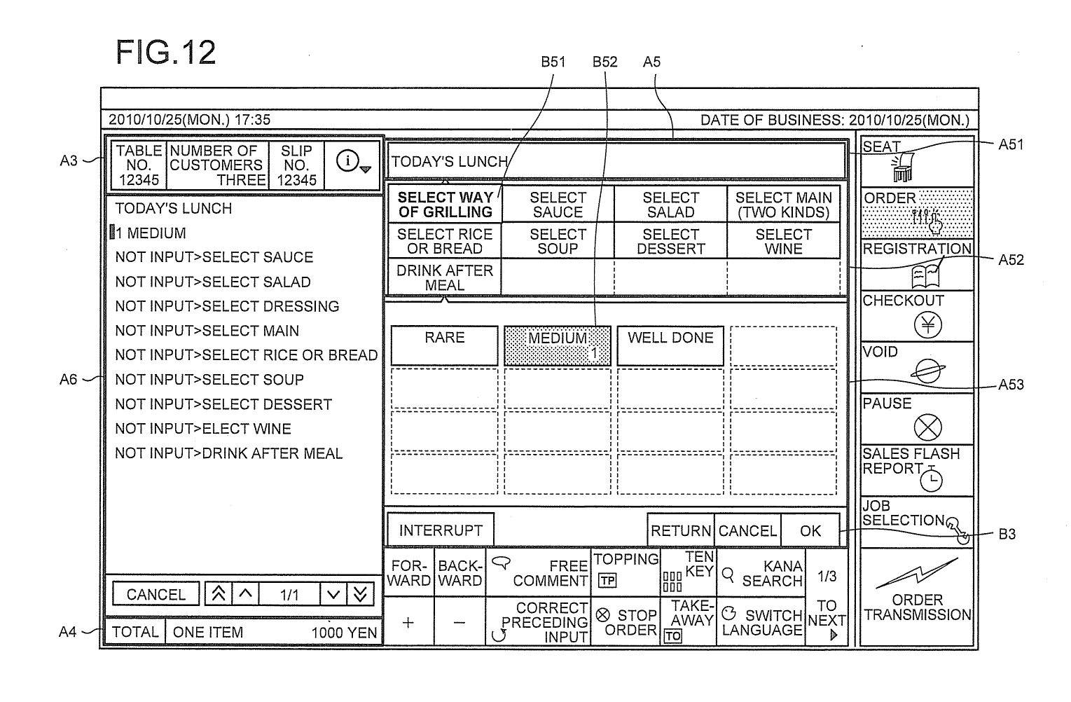

If a sub-menu item selection button 552 corresponding to a sub-menu item name “medium” is pressed in the area A53 shown in FIG. 11 in Act 34, the CPU 51 adds 1 to the number of ordered items of a sub-menu item having the sub-menu item name and, as shown in FIG. 12, causes the display with touch panel 55 to display a numerical value “1” representing the number of ordered items on the sub-menu item selection button B52. The CPU 51 causes the display with touch panel 55 to display the number of ordered items “1” and the selected sub-menu item name “medium” in the area A6 in association with each other. In FIG. 12, among items (sub-menu item group names) displayed in the area A6, an item corresponding to the sub-menu item group name selected in the area A52 is erased and the number of ordered items and the selected sub-menu item name are displayed in the position of the item in association with each other. However, display of the number of ordered items and the selected sub-menu item name is not limited to this example.

In FIG. 12, if the button 33 is pressed after the sub-menu item selection button B52 is pressed, the CPU 51 determines that the processing is not applied to all the sub-menu item group names displayed as the sub-menu item group selection buttons in the area A52. In this case, the CPU 51 returns the processing to Act 32 shown in FIG. 7. However, the CPU 51 may automatically select one of the unprocessed sub-menu item group names. In this case, for example, according to order set in advance (e.g., order of the sub-menu item group selection buttons displayed in the area A52), the CPU 51 automatically selects one sub-menu item group selection button. If another sub-menu item group selection button is pressed, the CPU 51 displays the sub-menu item selection button in the area A53 concerning the sub-menu item group selection button.

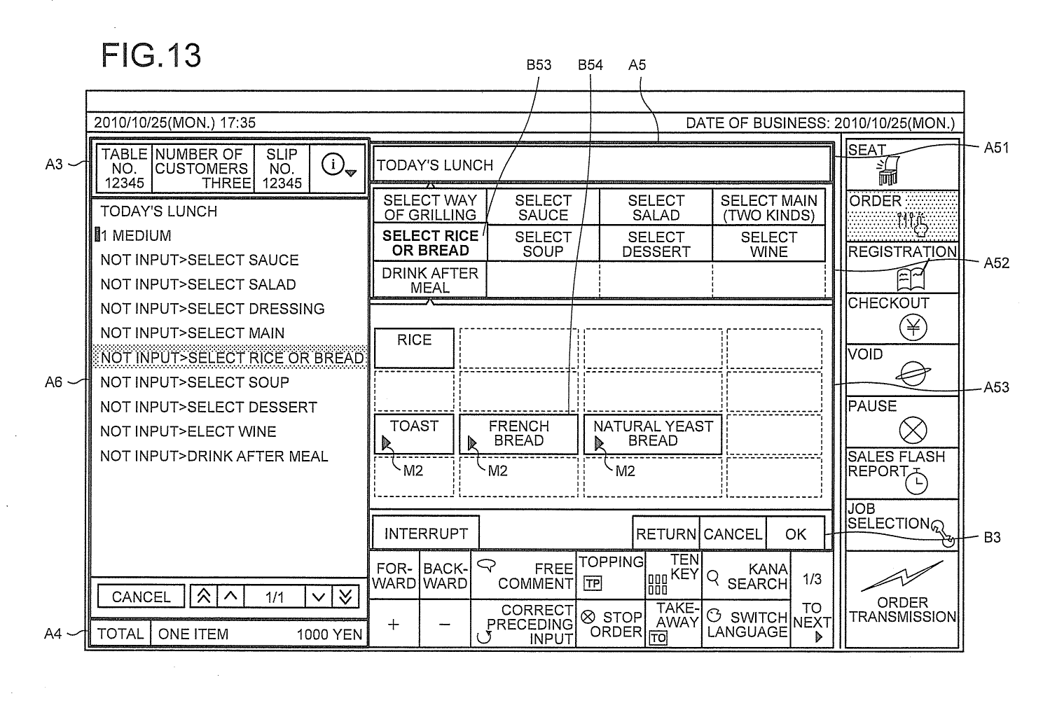

For example, if a sub-menu item group button 553 for selecting a sub-menu item group name “select rice or bread” is pressed as shown in FIG. 13 after the order concerning the sub-menu item group name “select a way of grilling” explained with reference to FIG. 12 is decided, the CPU 51 causes the display with touch panel 55 to display four sub-menu item selection buttons corresponding to sub-menu item names associated with the sub-menu item group name in the area A53. The button B3 under the area A53 is a button for deciding an order of a sub-menu item. Since the comment menu item group IDs are associated with the sub-menu item names (see FIG. 2), the CPU 51 causes the display with touch panel 55 to display, on the sub-menu item selection buttons, information M2 of a rectangular shape indicating that comment menu items are present.

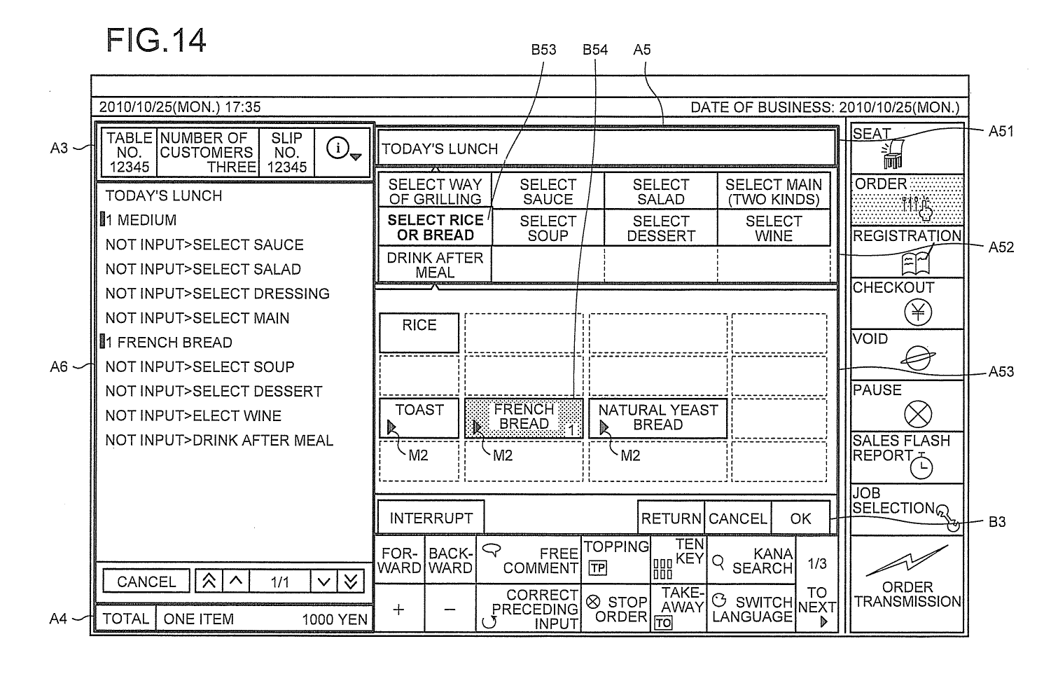

If a sub-menu item selection button B54 corresponding to a sub-menu item name “French bread” is pressed in the area A53, the CPU 51 adds 1 to the number of ordered items of a sub-menu item having the sub-menu item name and, as shown in FIG. 14, causes the display with touch panel 55 to display a numerical value “1” representing the number of ordered items on the sub-menu item selection button 554. The CPU 51 causes the display with touch panel 55 to display the number of ordered items and the selected sub-menu item name “French bread” in the area A6 in association with each other. In this case, since a comment menu item group ID is associated with the selected sub-menu item name “French bread”, the CPU 51 executes the comment menu item input processing in Act 38.

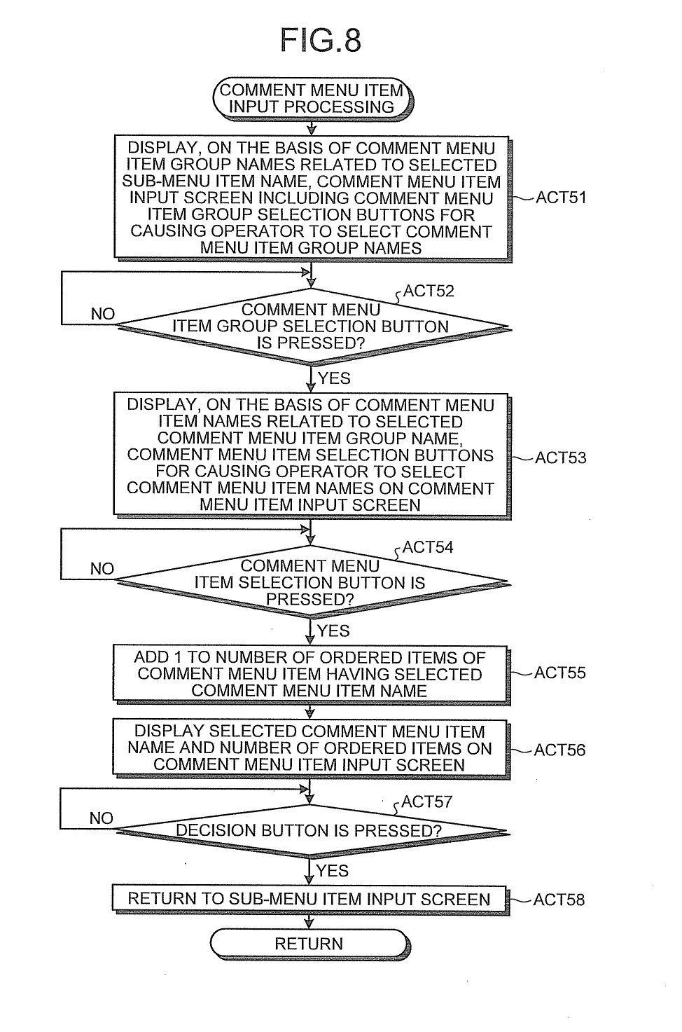

The comment menu item input processing in Act 38 is explained with reference to FIG. 8. FIG. 8 is a flowchart for explaining a procedure of the comment menu item input processing executed by the CPU 51.

First, the CPU 51 reads out, from the comment menu item file 13, comment menu item group names associated with comment menu item group IDs of the sub-menu item name selected in Act 34. The CPU 51 causes the display with touch panel 55 to display a comment menu item input screen including buttons for causing the operator to select the comment menu item group names (hereinafter referred to as comment menu item group selection buttons) (Act 51).

Subsequently, the CPU 51 stays on standby until any one of the comment menu item group selection buttons is pressed (No in Act 52). If the CPU 51 receives a pressing signal of a comment menu item group selection button via the touch-panel-input control unit 57 (Yes in Act 52), the CPU 51 reads out, from the comment menu item file 13, a comment menu item name related to a comment menu item group name selected by the pressing and causes the display with touch panel 55 to display buttons for causing the operator to select the comment menu item names (hereinafter referred to as comment menu item selection buttons) on the comment menu item input screen (Act 53).

The CPU 51 stays on standby until any one of the comment menu item selection buttons is pressed (No in Act 54). If the CPU 51 receives a pressing signal of the comment menu item selection button via the touch-panel-input control unit 57 (Yes in Act 54), the CPU 51 adds 1 to the number of ordered items of a comment menu item having the comment menu item name selected by the pressing (Act 55) and causes the display with touch panel 55 to display the selected comment menu item name and the number of ordered items on the comment menu item input screen (Act 56).

The CPU 51 stays on standby until a button for deciding order of a comment menu item is pressed (No in Act 57). If the CPU 51 receives pressing of the button (Yes in Act 57), the CPU 51 returns to the sub-menu item input screen (Act 58) and shifts to Act 39 in FIG. 7. In this way, the CPU 51 cooperates with the touch-panel-input control unit 57 to function as a third receiving unit.

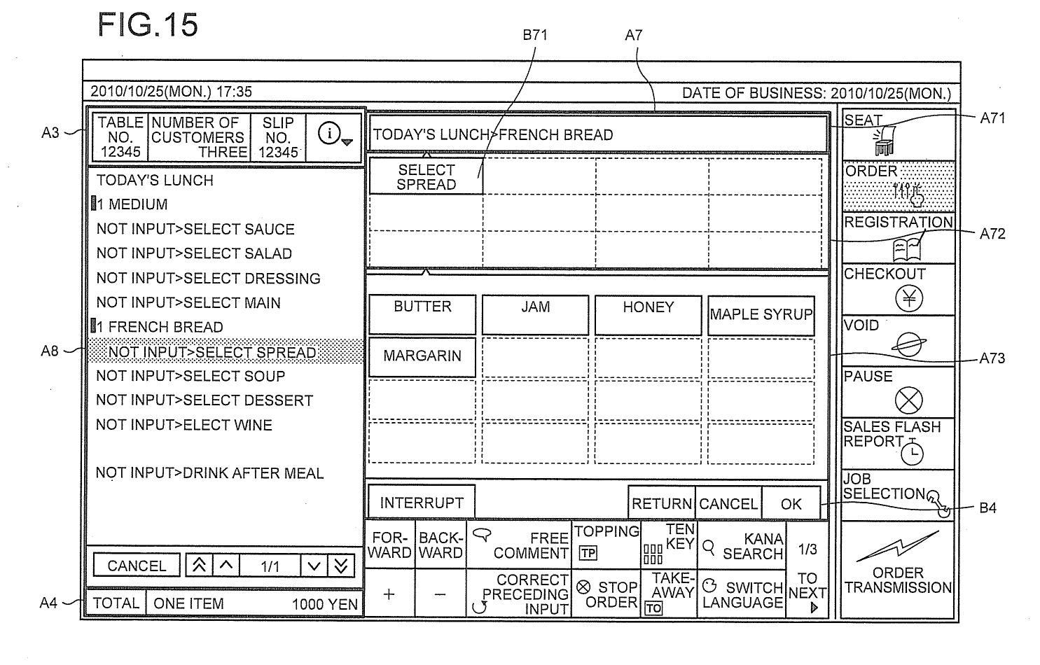

FIG. 15 is a diagram of an example of the comment menu item input screen displayed on the display with touch panel 55 by cooperation of the CPU 51 and the display control unit 56. As shown in the figure, the CPU 51 and the display control unit 56 (a fourth display control unit and the third display control unit) displays a comment menu item input screen including an area A7 (a fourth area) for selectably displaying a list of comment menu items and an area A8 (a third area) for displaying information concerning a comment menu item group, an order of which is received. In the comment menu item input screen, the areas A5 and A6 of the sub-menu item input screen are switched to the areas A7 and A8.

In the area A7, an area A71 is an area for displaying the menu item name selected in Act 16 and the sub-menu item name selected in Act 34. In the example shown in FIG. 15, the menu item name “today's lunch” is selected and the sub-menu item name “French bread” is selected.

An area 72 is an area in which comment menu item group selection buttons are displayed. In the example shown in FIG. 15, according to selection of the sub-menu item name “French bread”, one sub-menu item group selection button corresponding to the sub-menu item group ID “12” shown in FIG. 4 is displayed in the area A72.

An area A73 is an area in which comment menu item selection buttons are displayed. In the example shown in FIG. 15, according to selection of a comment menu item group selection button B71 corresponding to a comment menu item group name “select a spread”, five comment menu item selection buttons corresponding to comment menu item names associated with the comment menu item group name are displayed in the area A73. A button B4 under the area A73 is a button for deciding an order of a comment menu item.

The area A8 is an area for displaying information concerning comment menu items. In the area A8, a list of comment menu items accompanying a selected sub-menu item name is displayed to make it possible to distinguish whether the comment menu items are selected (ordered). In the example shown in FIG. 15, the selected menu item name “today's lunch” and the selected sub-menu item name “French bread” are displayed and “not input” is written in a comment menu corresponding to the sub-menu item name, whereby the sub-menu item name is displayed to make it possible to distinguish that the sub-menu item name is unselected.

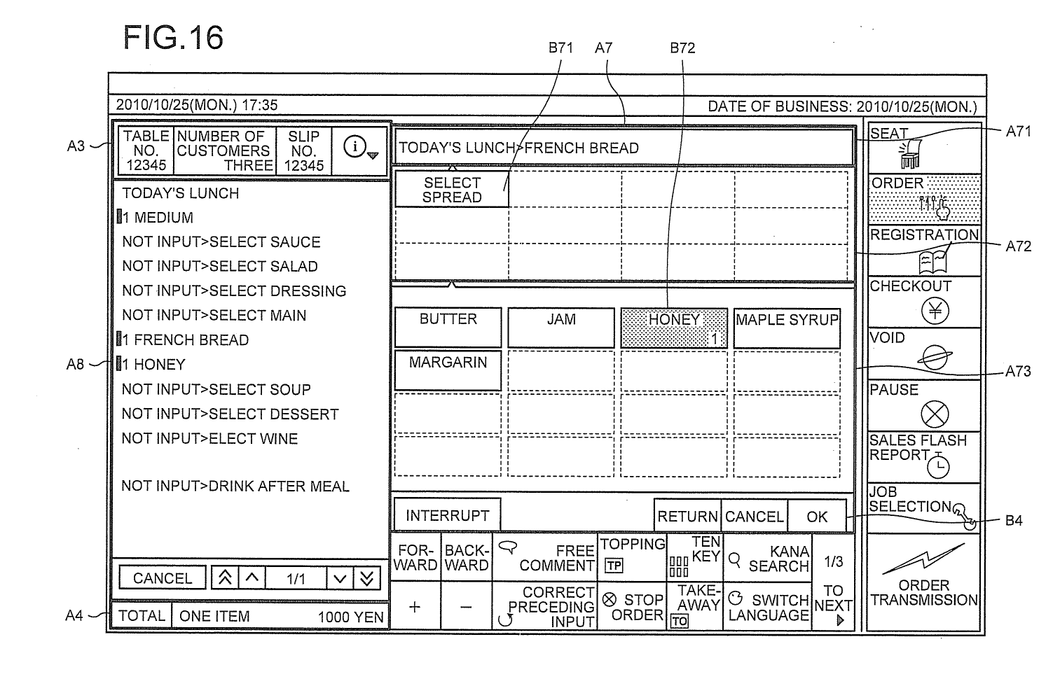

If a comment menu item selection button 572 corresponding to a comment menu item name “honey” is pressed in the area A73 shown in FIG. 15 in Act 54 described above, the CPU 51 adds 1 to the number of ordered items of a comment menu item having the comment menu item name and, as shown in FIG. 16, causes the display with touch panel 55 to display a numerical value “1” representing the number of ordered items on the comment menu item selection button B72. The CPU 51 causes the display with touch panel 55 to display the number of ordered items “1” and the selected comment menu item name “honey” in the area A8 in association with each other. In FIG. 16, among the items (the comment menu item group names) displayed in the area A8, an item corresponding to the comment menu item group name selected in the area A72 is erased and the number of ordered items and the selected comment menu item name are displayed in the position of the item in association with each other. However, display of the number of ordered items and the selected sub-menu item name is not limited to this example.

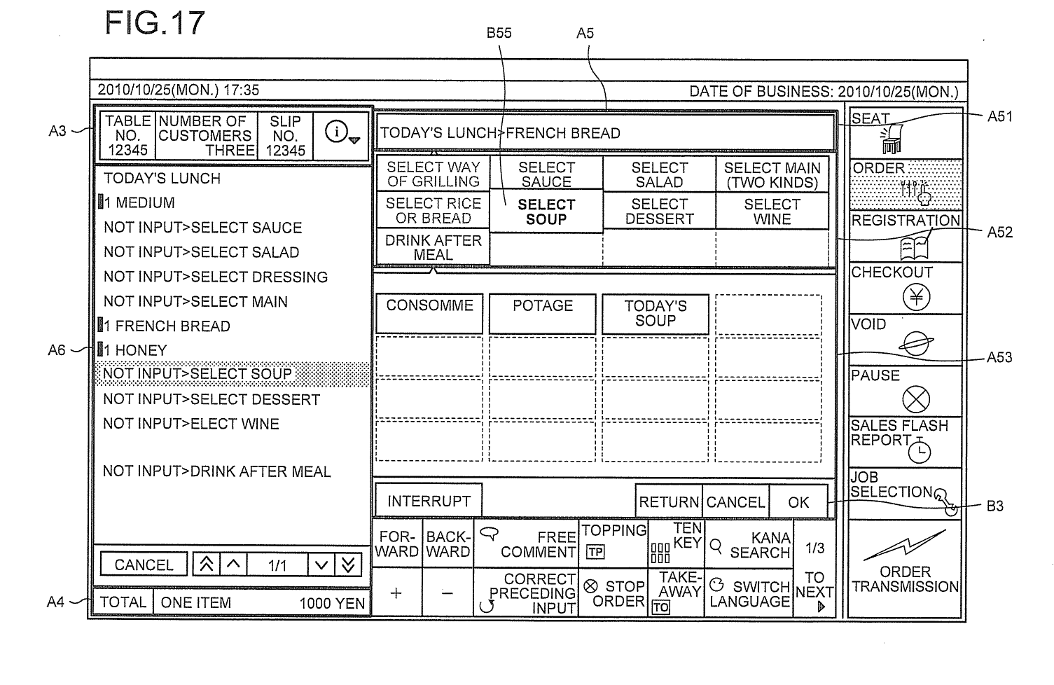

In FIG. 16, if the button 54 is pressed, the CPU 51 switches the area A7 to the area A5 and reflects content of the area A8 on the area A6 to return to the sub-menu item input screen as shown in FIG. 17. In an example shown in FIG. 17, a sub-menu item group button 555 for selecting a sub-menu item group name “select soup” is pressed.

Referring back to FIG. 7, if the CPU 51 determines in Act 40 that the processing in Acts 32 to 39 is applied to all the sub-menu item groups displayed in Act 31 (Yes in Act 40), the CPU 51 switches the sub-menu item input screen to the menu item input screen to return to the menu item input screen (Act 41) and shifts to Act 21 in FIG. 6.

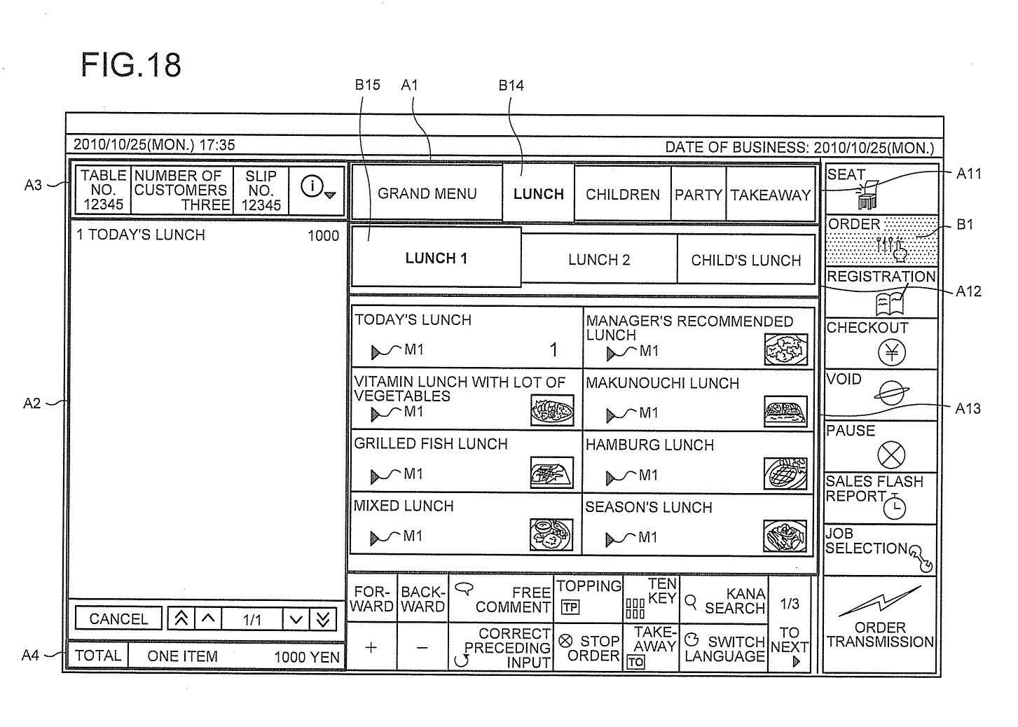

FIG. 18 is a diagram of a menu item input screen displayed after all the sub-menu item group selection buttons (the sub-menu item group names) displayed in the area A52 in FIG. 11 are processed. In this state, if a button B5 for instructing completion of an order is pressed, the menu item names (the sub-menu item names and the comment menu item names) selected so far and the numbers of ordered items are transmitted to the order management apparatus 10 as order menu item information together with a table number and a slip number.

Referring back to FIG. 6, in Act 21, the CPU 51 determines whether a button for instruction completion of an order (the button B5 in FIG. 18) is pressed. If the CPU 51 cannot confirm pressing of the button for instructing completion of an order (No in Act 21), the CPU 51 returns to Act 16. If the CPU 51 receives pressing of the button for instructing completion of an order (Yes in Act 21), the CPU 51 transmits the menu item names (the sub-menu item names and the comment menu item names) selected so far and the numbers of ordered items to the order management apparatus 10 as order menu item information in association with the table number and the slip number (Act 22) and ends the processing.

As explained above, according to this embodiment, even if an order of a main menu item having plural sub-menu items (sub-menu item group IDs) is made, it is possible to make orders concerning the sub-menu items in arbitrary order. Therefore, since it is possible to deal with orders of sub-menu items arbitrarily designated by customers, it is possible to improve convenience concerning order input of sub-menu items.

The embodiment of the present invention is explained above. However, the present invention is not limited to this. Various modifications, replacements, additions, and the like are possible without departing from the spirit of the present invention.

For example, in the embodiment, the order input apparatus 50 executes the order input processing. However, the present invention is not limited to this. Another apparatus (e.g., the POS terminal 40) may execute the order input processing. The order input apparatus 50 may be applied to a handy terminal that can be carried by an attendant.

In the embodiment, FIG. 9 is shown as an example of the menu item input screen. However, a screen structure and a layout are not limited to this example. For example, in the embodiment, the first area (e.g., the area A1 in FIG. 10) for displaying menu items and the second area (e.g., the area A5 in FIG. 11) for displaying sub-menu items are switched to display the first area and the second area in the different screens. However, the present invention is not limited to this. The first area and the second area may be displayed in the same screen. In the embodiment, the second area (e.g., the area A5 in FIG. 11) for displaying sub-menu items and the fourth area (e.g., the area A7 in FIG. 15) for displaying comment menu items are switched to display the second area and the fourth area in the different screens. However, the present invention is not limited to this. The second area and the fourth area may be displayed in the same screen.

A computer program executed by the order input apparatus 50 according to the embodiment may be provided while being incorporated in a ROM or the like in advance. The computer program may be provided while being recorded in a computer-readable recording medium such as a CD-ROM, a flexible disk (FD), a CD-R, or a DVD in a file of an installable format or an executable format.

The computer program may be provided by being stored on a computer connected to a network such as the Internet and downloaded through the network. The computer program may be provided or distributed through the network such as the Internet.

What is claimed is:

1. An order input apparatus comprising:
a first storing unit configured to store therein plural menu items and plural sub-menu items in association with one another, the sub-menu items accompanying the menu items;
a first display control unit configured to display a list of the plural menu items in a first area in a display screen of a display unit;
a first receiving unit configured to receive selection of any menu item out of the list of the menu items displayed in the first area;
a second display control unit configured to display a list of the sub-menu items accompanying the menu item, the selection of which is received by the first receiving unit, in a second area in the display screen;
a second receiving unit configured to receive selection of any sub-menu item out of the list of the sub-menu items displayed in the second area; and
an order processing unit configured to manage, as order menu item information, the menu item and the sub-menu item, the selection of which is received by the first receiving unit and the second receiving unit.

2. The apparatus according to claim 1, wherein the first display control unit adds, to the menu items stored in association with the sub-menu items, information indicating that the sub-menu items accompany the menu items and displays the information in the first area.

3. The apparatus according to claim 1, wherein the order processing unit suspends decision of the order menu item information until orders concerning all the sub-men items displayed in the second area are received.

4. The apparatus according to claim 1, further comprising a third display control unit configured to display, in a third area in the display screen, a list of the menu item and the sub-menu item, the selection of which is received by the first receiving unit and the second receiving unit.

5. The apparatus according to claim 4, wherein the third display control unit displays a list of plural sub-menu items accompanying the menu item, the selection of which is received by the first receiving unit, to make it possible to distinguish whether the sub-menu items are selected.

6. The apparatus according to claim 4, wherein the third display control unit sets, as numbers of ordered items, numbers of times selection of the same menu item and the same sub-menu item is received by the first receiving unit and the second receiving unit and displays the numbers of ordered items in association with the selected menu item and the selected sub-menu item.

7. The apparatus according to claim 1, further comprising:
a second storing unit configured to store therein plural comment menu items in association with the sub-menu items stored in the first storing unit, the comment menu items accompanying the sub-menu items;
a fourth display control unit configured to display, in a fourth area in the display screen, a list of the comment menu items accompanying the sub-menu item, the selection of which is received by the second receiving unit; and
a third receiving unit configured to receive selection of any comment menu item out of the list of the comment menu items displayed in the fourth area, wherein
the order processing unit manages, as the order menu item information, the menu item, the sub-menu item, and the comment menu item, the selection of which is received by the first receiving unit, the second receiving unit, and the third receiving unit.

8. The apparatus according to claim 7, wherein the second display control unit adds, to the sub-menu items stored in association with the comment menu items, information indicating that the comment menu items accompany the sub-menu items and displays the information in the second area.

9. An order input apparatus comprising:
a first storing unit configured to store therein plural menu items and plural sub-menu items in association with one another, the sub-menu items accompanying the menu items;
a first display control unit configured to display a list of the plural menu items in a first area in a display screen of a display unit;
a first receiving unit configured to receive selection of any menu item out of the list of the menu items displayed in the first area;
a second display control unit configured to display a list of the sub-menu items accompanying the menu item, the selection of which is received by the first receiving unit, in a second area in the display screen;
a second receiving unit configured to receive selection of any sub-menu item out of the list of the sub-menu items displayed in the second area; and
a third display unit configured to display a list of the menu item and the sub-menu item, the selection of which is received by the first receiving unit and the second receiving unit, in a third area in the display screen.

10. An order input method executed by an order input apparatus, the order input method comprising:
displaying a list of plural menu items in a first area in a display screen of a display unit;
receiving selection of any menu item out of the list of the menu items displayed in the first area;
displaying a list of the sub-menu items accompanying the menu item, the selection of which is received, in a second area in the display screen;
receiving selection of any sub-menu item out of the list of the sub-menu items displayed in the second area; and
managing, as order menu item information, the menu item and the sub-menu item, the selection of which is received.
